(19) United States
(12) Patent Application Publication
(10) Pub. No.: US 2002/0056180 A1
(43) Pub. Date: May 16, 2002

(54) Method and apparatus for replacing gripping member on wire bucket handle

(76) Inventor: Timothy M. Crawley, Glendale, AZ (US)

Correspondence Address: Tod R. Nissle, Esq., TOD R. NISSLE, P.C., P.O. Box 55630, Phoenix, AZ, 85078, US

(21) Appl. No.: 10/038,256

(22) Filed: Oct. 29, 2001

Related U.S. Application Data
(60) Provisional application No. 60/244,713, filed on Oct. 30, 2000.

(51) Int. Cl. B23P 17/04

(52) U.S. Cl. 29/401.1

(57) ABSTRACT

An apparatus and method for replacing the gripping member of the handle of a bucket. The replacement gripping member includes a plurality of interfitting pieces which can be installed on the handle of a bucket without requiring that the handle be removed from the bucket.

This invention pertains to buckets.

More particularly, this invention pertains to a method and apparatus for replacing the damaged or degraded handle on a bucket.

Cylindrical buckets which hold five gallons of paint, acrylic coating, or other liquids are well known and widely used. The cylindrical container portion of the bucket is usually fabricated from plastic, while the handle includes two parts. The first part comprises an elongate metal wire or arm having a diameter of about one-eighth of an inch. The metal arm is bent into a generally semi-circular shape. The ends of the arm are bent to engage portions of the top of the cylindrical container. The arm also include a central section intermediate the ends of the arm. The second part of the handle is a cylindrical gripping member which rotatably fits on the central section of the arm and which is shaped to comfortably contour to the hand of a user. The cylindrical gripping member is typically made from plastic and includes a honeycomb interior. The plastic comprising the gripping member degrades and breaks, especially when subjected to sunlight. After the gripping member breaks, the bucket is often discarded because a new gripping member is not readily available.

Accordingly, it would be highly desirable to provide an improved method and apparatus for replacing the gripping member on a bucket.

Therefore, it is a principal object of the invention to provide an improved method and apparatus for retrofitting the handle of a bucket with a new gripping member.

Another object of the invention is to provide an improved method and apparatus for retrofitting the semi-circular wire arm of a five gallon bucket with a new gripping member without requiring that the arm be removed from the bucket.

A further object of the invention is to provide an improved method and apparatus for reducing the quantity of buckets which are, even though the container is in good condition and can be used for an extended period of time, discarded because the gripping member is damaged or missing.

These and other, further and more specific objects and advantages of the invention will be apparent to those skilled in the art from the following detailed description thereof, taken in conjunction with the drawings, in which:

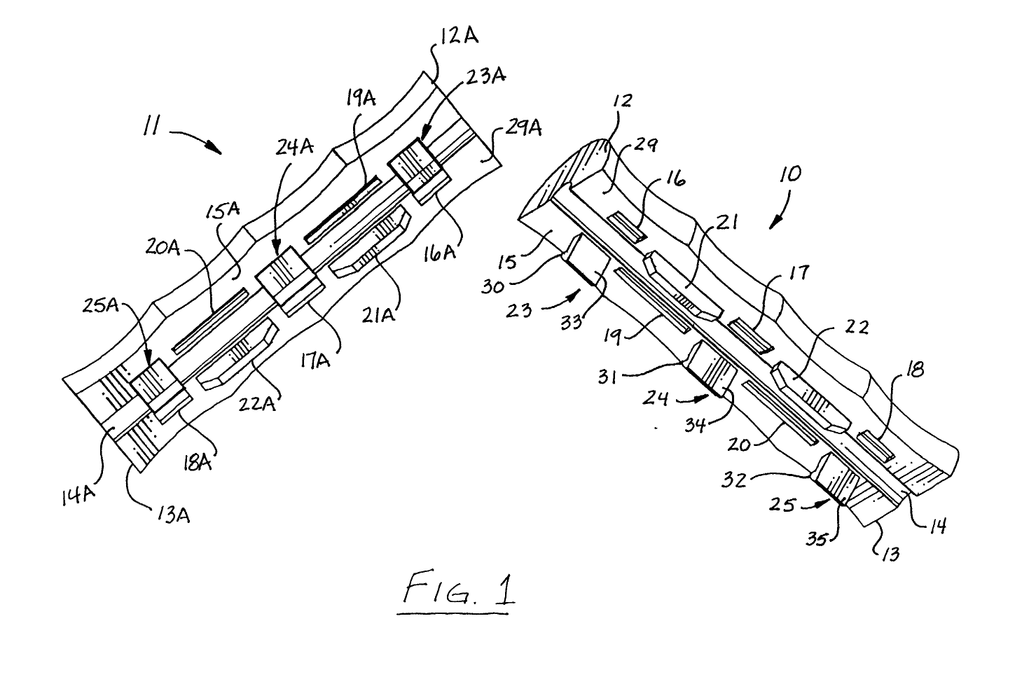

FIG. 1 is a perspective view illustrating a pair of opposing halves of a gripping member constructed in accordance with the principles of the invention;

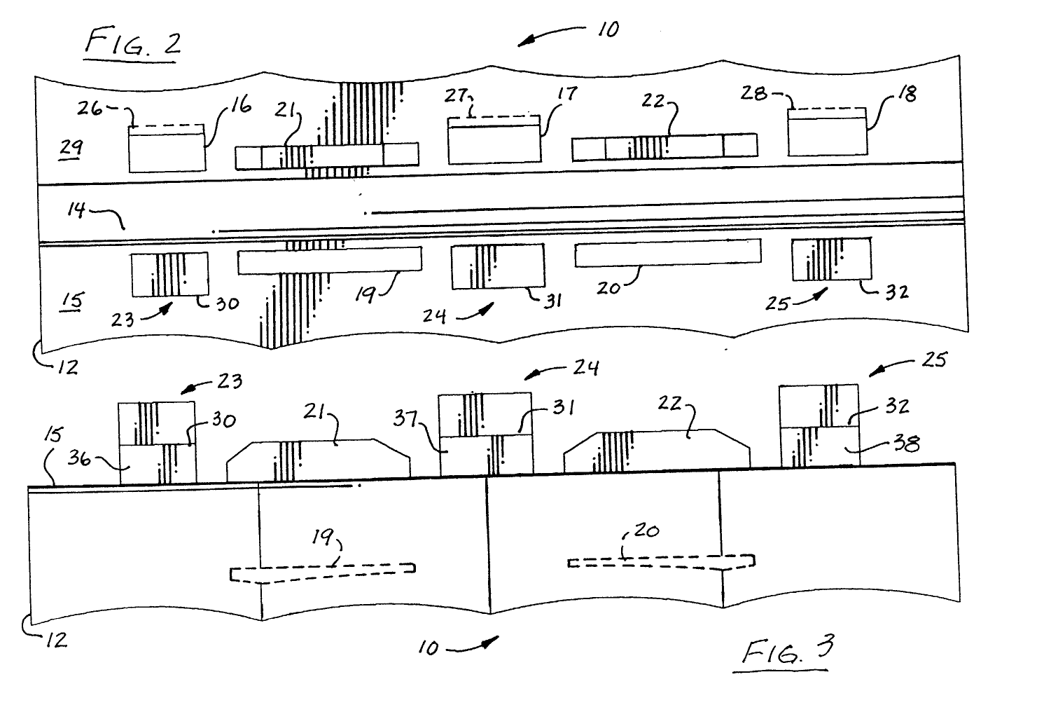

FIG. 2 is top view illustrating further construction details of one of the gripping member halves of FIG. 1;

FIG. 3 is a side view illustrating the gripping member half of FIG. 2;

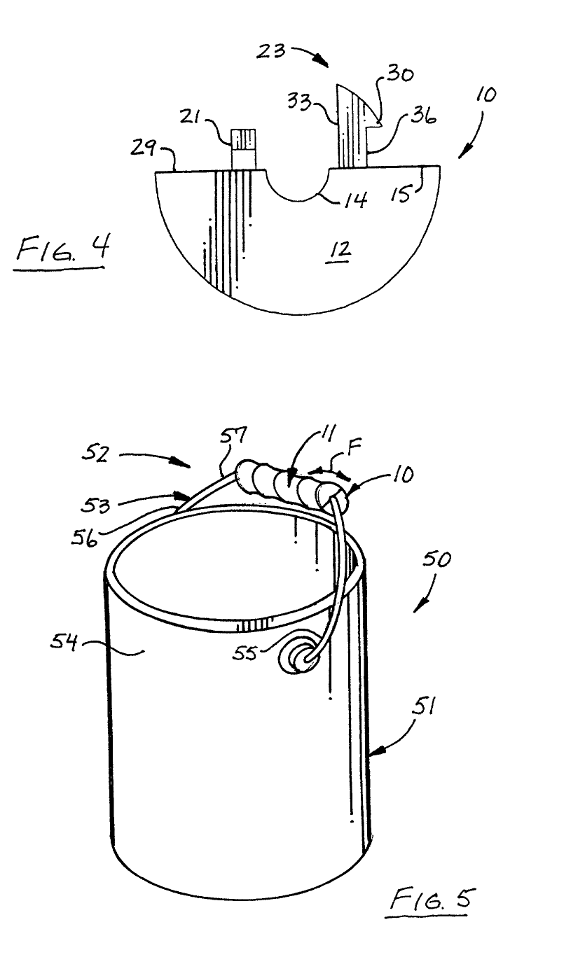

FIG. 4 is an end view illustrating the gripping member half of FIG. 3; and,

FIG. 5 is a perspective view of a bucket illustrating the gripping member of the invention installed thereon.

Briefly, in accordance with the invention, I provide an improved method for retrofitting a bucket. The bucket includes a cylindrically shaped container including an upper portion, and a wire member. The wire member includes first and second ends attached to the upper portion of the container; a central section intermediate the first and second ends; and, a gripping member mounted on the central section of the wire member. The improved method includes the steps of removing the gripping member; and, providing a replacement unit for the gripping member. The replacement unit includes a plurality of pieces shaped and dimensioned to interfit with one another and circumscribe the central section of the wire member. The improved method also includes the step of mounting the replacement unit on the central section of the wire member by interfitting the plurality of pieces.

In another embodiment of the invention, I provide improvements in combination with a bucket. The bucket includes a cylindrically shaped container including an upper portion, and a wire member. The wire member includes first and second ends attached to the upper portion of the container; and, a central section intermediate the first and second ends. The improvements comprise apparatus for grasping the wire member and include a plurality of pieces shaped and dimensioned to interfit around the central section of the wire member.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 is an exploded view illustrating the interfitting units 10 and 11 which snap together to produce the gripping member of the invention. The shape and dimension of unit 11 is identical to that of unit 10, although this need not be the case.

Unit 10 is illustrated in more detail in FIGS. 2 to 4 and includes opposed, spaced apart, parallel, semi-circular end surfaces 12, 13 and semi-cylindrical notch or groove 14 extending between end surfaces 12 and 13. Flat, co-planar surfaces 15, 29 extend outwardly from groove 14.

Notches 16, 17, 18 extend downwardly from surface 29 into unit 10. Guide tabs 21, 22 extend outwardly from surface 29. The shape and dimension of tab 21 is identical to that of tab 22.

Notches 19, 20 extend downwardly from surface 15 into unit 10. Clip tabs 23, 24, 25 extend outwardly from surface 15. Each tab 23 to 25 includes a lip 30 to 32, respectively. Tab 23 includes a back surface 33 normal to surface 15 and parallel to front surface 36 (FIG. 3). Tab 24 includes a back surface 34 normal to surface 15 and parallel to front surface 37 (FIG. 3). Tab 25 includes a back surface 35 normal to surface 15 and parallel to front surface 38 (FIG. 3). The shape and dimension of tab 23 is identical to that of each tab 24, 25.

The shape and dimension of each tab 23A to 25A of unit 11 is identical to the shape and dimension of each tab 23 to 25 of unit 10. Tab 23A includes a lip 30, back surface 33, and front surface 36; tab 24A includes a lip 31, back surface 34, and front surface 37; etc.

The shape and dimension of each tab 21A and 22A of unit 11 is identical to the shape and dimension of each tab 21, 22 of unit 10.

The shape and dimension of each notch 16A to 18A of unit 11 is identical to the shape and dimension of each notch 16 to 18 of unit 10.

The shape and dimension of each notch 19A, 20A of unit 11 is identical to the shape and dimension of each notch 19, 20 of unit 10.

Notch 16 includes a detent or lip 26 (FIG. 2). Notch 16 is shaped and dimensioned such that when clip tab 23A of unit 11 is slidably inserted in notch 16, lip 30 of tab 23A snaps into detent 26 to secure clip tab 23A in notch 16. Tab 23 of unit 10 similarly snaps into and is secured in notch 16A of unit 11.

Notch 17 includes a detent or lip 27. Notch 17 is shaped and dimensioned such that when clip tab 24A of unit 11 is slidably inserted in notch 17, lip 31 of tab 24A snaps into detent 27 to secure tab 24A in notch 17. Tab 24 of unit 10 similarly snaps into and is secured in notch 17A of unit 11.

Notch 18 includes a detent or lip 28. Notch 18 is shaped and dimensioned such that when clip tab 25A of unit 11 is slidably inserted in notch 18, lip 32 of tab 25A snaps into detent 28 to secure tab 25A in notch 18. Clip tab 25 of unit 10 similarly snaps into and is secured in notch 18A of unit 11.

Notch 19 slidably receives guide tab 21A of unit 11. Notch 19A of unit 11 slidably receives guide tab 21 of unit 10.

Notch 20 of unit 10 slidably receives guide tab 22A of unit 11. Notch 20A of unit 11 slidably receives guide tab 22 of unit 10.

Each notch 19, 20, 23 to 25 can extend partially or completely through unit 10. In FIG. 3, dashed lines 19, 20 indicate the appearance of unit 10 when notches 19 and 20 extend completely through unit 10.

The shape and dimension of notch 16 is identical to that of notches 17 and 18. The shape and dimension of notch 19 is identical to that of notch 20.

Unit 11 includes end surfaces 12A and 13A.

In FIG. 5, bucket 50 includes cylindrical container 51 and handle 52. Handle 52 includes semi-circular wire member 53 and a gripping member including units 10 and 11. Wire member 53 includes ends 55 and 56 pivotally connected to the top portion 54 of container 51. Member 53 also includes a central portion 57 intermediate ends 55 and 56. The gripping member is mounted on central portion 57.

In use, the original gripping member (not shown) is removed from the central portion of wire member 53. The gripping member of the invention is mounted on the central portion of wire member 53 by snapping together units 10 and 11 such that the central portion 57 nests and rests in grooves 14, 14A. When units 10 and 11 are snapped together, grooves 14, 14A collectively form a cylindrical channel through which the central portion 57 of wire member 53 extends, preferably such that the gripping member can readily rotate around wire member 53 in the directions indicated by arrows F in FIG. 5.

As earlier described, when units 10 and 11 are snapped together on wire member 53, tabs 23 to 25 snap into notches 16A to 18A, respectively; tabs 23A to 25A snap into notches 16 to 18, respectively; guide tabs 21A, 22A slide into notches 19 and 20, respectively; guide tabs 21, 22 slide into notches 19A and 20A, respectively; surface 15A is parallel to and contacts surface 29; and surface 29A is parallel to and contacts surface 15. The number of tabs and/or notches can vary as desired. The combination of clip tabs and guide tabs is preferred in the practice of the invention because it facilitates a secure interfitting of units 10 and 11.

Having described my invention in such terms as to enable those of skill in the art to make and practice it, and having described the presently preferred embodiments thereof,

I claim:

1. A method for retrofitting a bucket including
a cylindrically shaped container including an upper portion,
a wire member including
first and second ends attached to the upper portion of the container,
a central section intermediate the first and second ends,
a gripping member mounted on the central section of the wire member,
the method including the steps of
(a) removing the gripping member;
(b) providing a replacement unit for the gripping member, the replacement unit including a plurality of pieces shaped and dimensioned to interfit with one another and circumscribe the central section of the wire member;
(c) mounting the replacement unit on the central section of the wire member by interfitting said plurality of pieces.

2. In combination with a bucket, the bucket including
a cylindrically shaped container including an upper portion,
a wire member including
first and second ends attached to the upper portion of the container,
a central section intermediate the first and second ends,
the improvements comprising means for grasping the wire member and including a plurality of pieces shaped and dimensioned to interfit around the central section of the wire member.
